(19) United States
(12) Patent Application Publication
(10) Pub. No.: US 2026/0196808 A1
(43) Pub. Date: Jul. 9, 2026

(54) SPARK PLUG

(71) Applicant: INNIO Jenbacher GmbH & Co OG, Jenbach (AT)

(72) Inventor: Alexander Hofer, Munchen (DE)

(21) Appl. No.: 19/444,081

(22) Filed: Jan. 8, 2026

(30) Foreign Application Priority Data
Jan. 9, 2025 (EP) 25150986

(51) Int. Cl. H01T 13/32; F02B 19/12; H01T 13/34

(52) U.S. Cl. CPC H01T 13/32; F02B 19/12; H01T 13/34

(57) ABSTRACT

Spark plug for igniting a combustible gaseous fuel mixture in an internal combustion engine, comprising an ignition area, wherein the spark plug is configured to deliver an ignition energy in the ignition area, wherein at least one supply channel for conveying fuel and/or air is provided, the at least one supply channel having an exit opening at the ignition area and an entrance opening positioned distanced from the ignition area.

### CROSS-REFERENCE TO RELATED APPLICATION

This application claims priority to and benefit of European patent Application No. EP 25150986.5, filed on January 9, 2025, entitled “SPARK PLUG”, which is herein incorporated by reference in its entirety for all purposes.

### FIELD OF THE INVENTION

The present invention concerns a spark plug for igniting a combustible gaseous fuel mixture in an internal combustion engine, in particular for a gas engine having pre-chambers, with the features of the preamble of claim 1 and an internal combustion engine having such a spark plug.

### BACKGROUND

During operation of an internal combustion engine, temperatures of over 1000 °C are reached inside a combustion chamber of the internal combustion engine, which are also the temperatures to which the ignition device of the spark plug is exposed.

Exposed to these temperatures, the ignition device of the spark plug reaches up to 850 °C during operation. This heat has to be dissipated in order to protect the spark plug, or more precisely the ignition device, from damage and to achieve the longest possible service life of the spark plug.

It is commonly known to transfer heat from the ignition device via heat conduction to the spark plug housing or the spark plug base body, with the spark plug housing or the spark plug base body (in most cases threaded or screwed into the cylinder head or the spark plug sleeve) in turn dissipating the heat to surrounding components, such as a cylinder head or a spark plug sleeve.

Due to the efforts to improve the lifetime of a spark plug, the requirements regarding temperature management, i.e., enabling proper heat transfer between the spark plugs on the one hand and the cylinder head or the spark plug sleeves on the other hand, became more and more important.

### BRIEF DESCRIPTION

Therefore, an aspect of the present disclosure is to provide a spark plug with improved temperature management and/or to implement a spark plug with an increased service life due to better heat dissipation.

This aspect is achieved by a spark plug for an internal combustion engine having the features of claim 1 and an internal combustion engine having such a spark plug.

Accordingly, a spark plug for igniting a combustible gaseous fuel mixture in an internal combustion engine comprises an ignition area, wherein the spark plug is configured to deliver an ignition energy in the ignition area and at least on supply channel, wherein the at least one supply channel for conveying fuel and/or air is provided, the at least one supply channel having an exit opening at the ignition area and an entrance opening positioned distanced from the ignition area.

By use of the at least one supply channel, air, fuel or a mixture of air-fuel (an air-fuel mixture) can be supplied to the combustion chamber or pre-chamber passing, preferably passing via, the ignition area of the spark plug.

Therefore, the air, fuel or air-fuel mixture supplied to the combustion chamber or pre-chamber can be used for active cooling of the ignition area and the surrounding components of the spark plug.

By use of a more effective way of heat dissipation from the ignition device, the service life of the spark plug can be increased significantly.

The spark plug particularly preferably comprises an ignition device, preferably electrodes for creating an ignition spark, arranged in or near to the ignition area, wherein a possibility is provided to actively cool the ignition device of the spark plug and therefore provide an alternative or additional way of heat dissipation.

In other embodiments, the spark plug and the ignition device are configured to focus a laser beam onto the ignition area for creating the ignition energy in the ignition area (laser spark plug). In such embodiments, the at least one supply channel also actively cools the components near the ignition area when the fuel and/or air is conveyed through the at least one supply channel.

Advantageous embodiments of the invention are defined in the dependent claims

It can be provided that the spark plug comprises a – preferably rotationally symmetric – base body having a receiving cavity, wherein an ignition device is arranged at and/or in the receiving cavity, particular preferred wherein the ignition device is at least partially surrounded by the base body.

The base body of the spark plug may also be referred to as a spark plug housing.

It can be provided that the exit opening is arranged in the receiving cavity. Therefore, it may be provided that air, fuel or an air-fuel mixture passing through the supply channel is directly directed to the ignition device by placing the exit opening in the area of the receiving cavity.

It can be provided that the base body comprises, at an outer surface, a circumferential groove, wherein the entrance opening of the at least one supply channel is placed at the circumferential groove, preferably at the base of the groove.

By use of a circumferential groove, a relative rotational position between the spark plug and the surrounding parts (e.g., the cylinder head or the spark plug sleeve) does not have to be defined, as in each relative rotation position a provided air, fuel or air-fuel mixture can be delivered via the circumferential groove to the entrance opening of the supply channel.

It can be provided that the spark plug comprises a mounting portion, preferably a threaded surface, for mounting the spark plug in the internal combustion engine and/or in a cylinder head and/or in a spark plug sleeve, wherein the entrance opening is arranged at the mounting portion.

It can be provided that the mounting portion - comprises at least a partial external thread, and/or. - at least partially surrounds the base body.

As mentioned, it can be provided that an ignition device of the spark plug comprises at least one middle electrode and at least one ground electrode, wherein a spark gap is provided between the at least one middle electrode and the least one ground electrode, preferably wherein the spark gap defines the ignition area.

It can be provided that the base body is designed as ground electrode carrier, preferably wherein the at least one ground electrode is connected to the ground electrode carrier by laser beam welding.

It can be provided that the at least one ground electrode is designed as ring electrode, wherein the ring electrode surrounds a middle electrode of circular shape at least partially, wherein an annular spark gap is formed between the ground electrode and the middle electrode. Preferably, the ground electrode is designed as a ring electrode having an inner diameter of 4 – 6 mm.

It can be provided that the at least one middle electrode is connected at a centrally arranged middle electrode carrier, preferably connected to the middle electrode carrier by laser beam welding.

It can be provided that an isolator is arranged between the middle electrode carrier and the ground electrode carrier.

Furthermore, the present disclosure provides an internal combustion engine comprising at least one cylinder head and a spark plug according to the previous disclosed embodiments, wherein the spark plug is arranged at the cylinder head facing a combustion chamber of the internal combustion chamber, wherein an injector and/or a valve, preferably a fuel injector, is fluidically connected to the entrance opening to supply air, fuel or air-fuel mixture by use of the supply channel to the combustion chamber passing, preferably passing via, the ignition area of the spark plug.

It can be provided that the internal combustion engine comprises at least one pre-chamber, wherein the ignition area of the spark plug faces the pre-chamber for igniting an air-fuel mixture in the pre-chamber.

### BRIEF DESCRIPTION OF THE DRAWINGS

Further details and advantages are apparent from the accompanying figures and the following description of the drawings. The figures show:

FIG. 1 illustrates a first embodiment of a cylinder head of an internal combustion engine having a spark plug,

FIG. 2 illustrates the detailed view identified in FIG. 1,

FIG. 3 illustrates a second embodiment of a cylinder head of an internal combustion engine having a spark plug,

FIG. 4 illustrates the detailed view identified in FIG. 3,

FIG. 5 illustrates a third embodiment of a cylinder head of an internal combustion engine having a spark plug, and

FIG. 6 illustrates the detailed view identified in FIG. 5,

FIG. 7 illustrates another detailed view identified in FIG. 1, and

FIG. 8 illustrates a similar detailed variant of FIG. 7.

### DETAILED DESCRIPTION

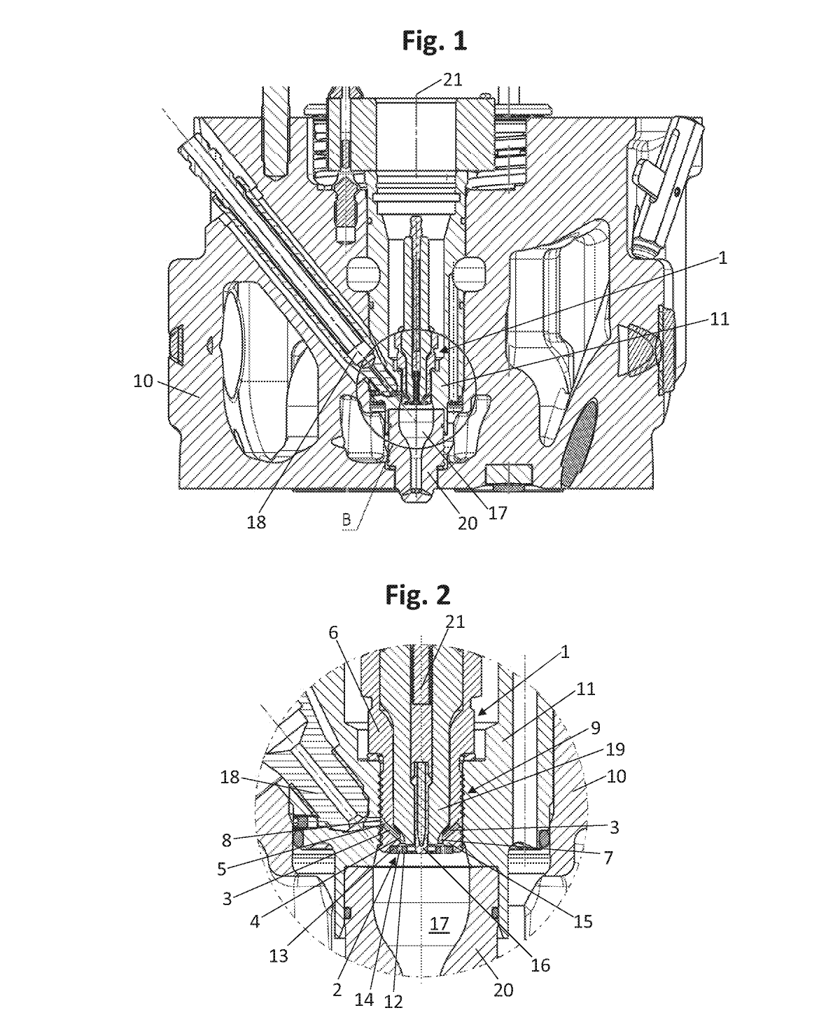

FIG. 1 shows a first embodiment of a cylinder head 10 of an internal combustion engine having a spark plug 1 (e.g., igniter). FIG. 2 shows detailed view B of FIG. 1.

The cylinder head 10 illustrated by FIGS. 1 and 2 comprises a pre-chamber 17, wherein the pre-chamber 17 and the whole pre-chamber assembly cooperating with the pre-chamber 17 is arranged in a cylinder head 10 of an internal combustion engine.

FIG. 2 represents a detail view of FIG. 1, wherein the region of the pre-chamber 17 and the components arranged therein, especially an ignition device 2 (e.g., ignition portion or section) of the spark plug 1, are depicted in a scaled up manner.

The pre-chamber 17 shown by this specific embodiment is formed by two separate components, which form a cavity in the mounted state. The upper part forming the pre-chamber 17 is a spark plug sleeve 11 and the lower part forming the pre-chamber 17 is a pre-chamber body 20, which are connected.

The spark plug sleeve 11 and the pre-chamber body 20 are placed in a cylinder head 10 of an internal combustion engine, wherein the pre-chamber body 20 (forming the distal end of the pre-chamber assembly) protrudes into a main combustion chamber of the internal combustion chamber.

The spark plug sleeve 11 carries the pre-chamber injector 18 and the spark plug 1, wherein the spark plug sleeve 11 comprises an upper opening which forms the proximal end of the pre-chamber assembly.

The pre-chamber injector 18 is fluidically connected to the supply channels 3 of the spark plug 1, and by use of the pre-chamber injector 18 and the supply channels 3, air, fuel or and air-fuel-mixture can be supplied to the pre-chamber 17.

The supply channels 3 of the spark plug 1 are arranged in the base body 6 (e.g., body portion) of spark plug 1 having an exit opening 4 at the ignition device 2 and an entrance opening 5 positioned distanced from the ignition device 2.

In particular, the entrance opening 5 of the supply channels 3 are provided at the outer surface of the base body 6 inside a circumferential groove 8 symmetrically surrounding the base body 6.

By use of the circumferential groove 8, the air, fuel or and air-fuel-mixture provided by the pre-chamber injector 18 can be supplied to the entrance openings 5 of the supply channels 3 independently from a rotational relative position of the spark plug 1 inside the pre-chamber sleeve 11.

The base body 6 is provided by at least four supply channels 3 evenly distributed around the outer surface of the base body 6, preferably being symmetrically arranged with regard to the central axis 21.

The outer surface of the base body 6 – being provided by the circumferential groove 8 – also provides the mounting portion 9 of the spark plug 1 for mounting the spark plug 1 inside the spark plug sleeve 11.

The mounting portion 9 is provided by an external threaded surface surrounding the base body 6.

The base body 6 comprises a receiving cavity 7 (e.g., ignition cavity), wherein the ignition device 2 is arranged at the receiving cavity 7.

Furthermore, in this embodiment the ignition device 2 is at least partially surrounded by the base body 6.

The exit openings 4 of the supply channels 3 are placed in the receiving cavity 7, wherein air, fuel or air-fuel mixture supplied via the supply channels 3 is passed via the ignition device 2 into the pre-chamber 17.

Therefore, the air, fuel or air-fuel mixture supplied to the pre-chamber 17 can be used for active cooling of the ignition device 2, wherein a possibility is provided to actively cool the ignition device 2 of the spark plug 2 and therefore provide an alternative or additional way of heat dissipation from the spark plug 1.

The ignition device 2 (e.g., ignition portion or section) of the spark plug 1 comprises an electrode assembly having a middle electrode 12 and a ground electrode 13, wherein a spark gap 14 is provided between the middle electrode 12 and the ground electrode 13.

The spark gap 14 and the close area in the vicinity of the spark gap 14 defines in this embodiment the ignition area of the spark plug 1.

The ground electrode 13 is designed as ring electrode, wherein the ring electrode surrounds a middle electrode 12 of circular shape and an annular spark gap 14 is formed between the ground electrode 13 and the middle electrode 12.

The base body 6 is designed as ground electrode carrier 15, wherein the at least one ground electrode 13 is connected to the ground electrode carrier 15 by laser beam welding.

The spark plug 1 furthermore comprises a centrally arranged middle electrode carrier 16, wherein the middle electrode 12 is connected to the middle electrode carrier 15 laser beam welding.

As can be seen, the only fluidical connection between the exit openings 4 of the supply channels 3 and the pre-chamber 17 is provided by the spark gap 14, wherein the air, fuel or air-fuel mixture provided by the supply channels 3 has to be passed via the spark gap 14 into the pre-chamber 17.

By use of such a configuration the electrodes 12,13 of the spark plug 1 effected to the highest thermal conditions can be cooled in the most effective way.

Between the middle electrode carrier 16 and the ground electrode carrier 15 (the base body 6) an isolator 19 is arranged.

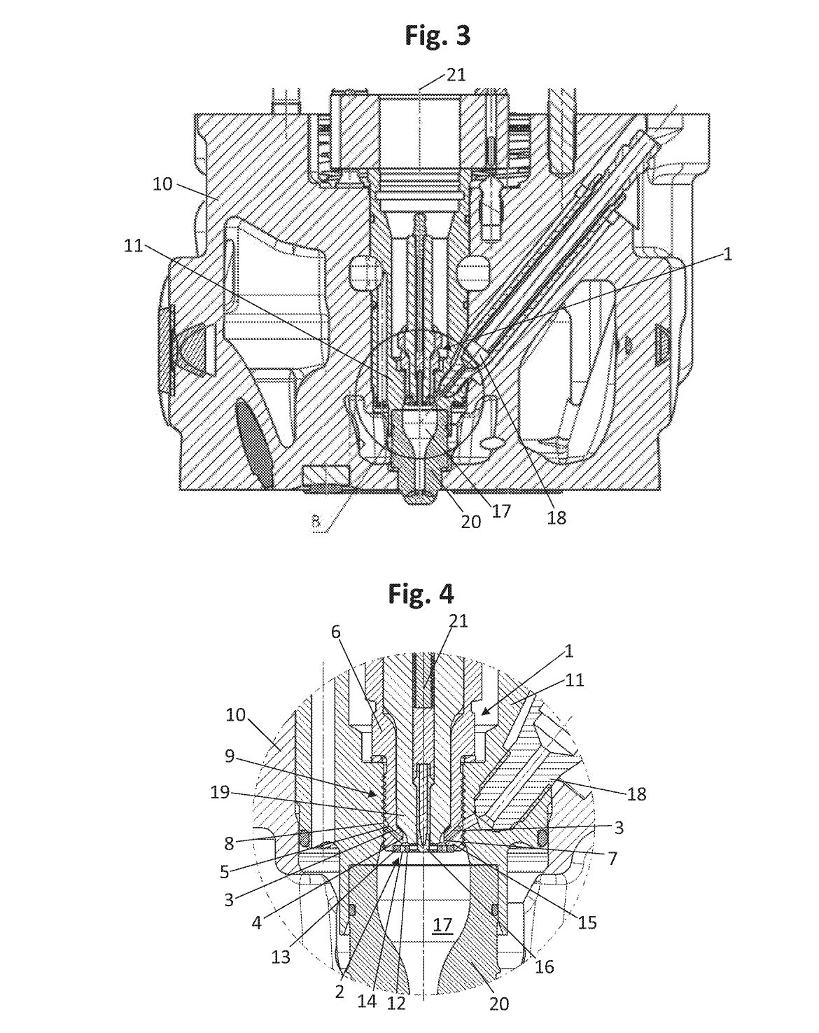

FIG. 3 shows a second embodiment of a cylinder head 10 of an internal combustion engine having a spark plug 1, wherein FIG. 4 shows a detailed view B of FIG. 3.

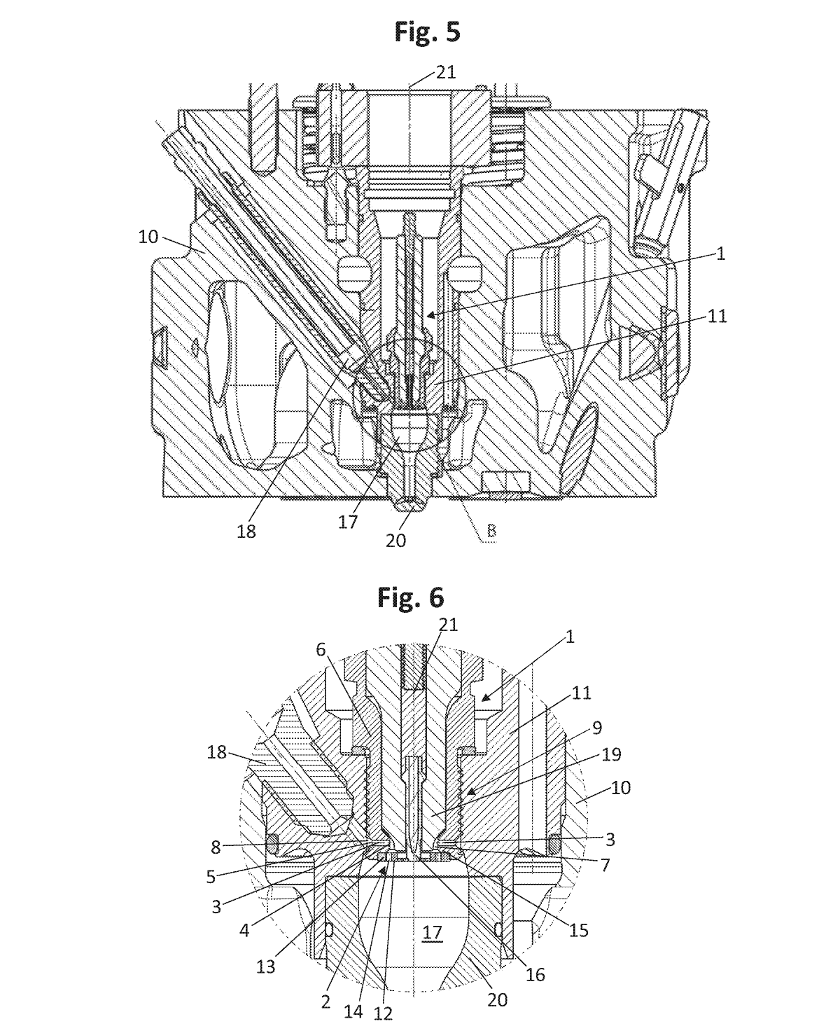

FIG. 5 shows a third embodiment of a cylinder head 10 of an internal combustion engine having a spark plug 1, wherein FIG. 6 shows a detailed view B of FIG. 5.

The first, second and third embodiments of a cylinder head mainly differ by the arrangements of the spark plugs 1, wherein the sizes and orientations of the supply channels 3 differ.

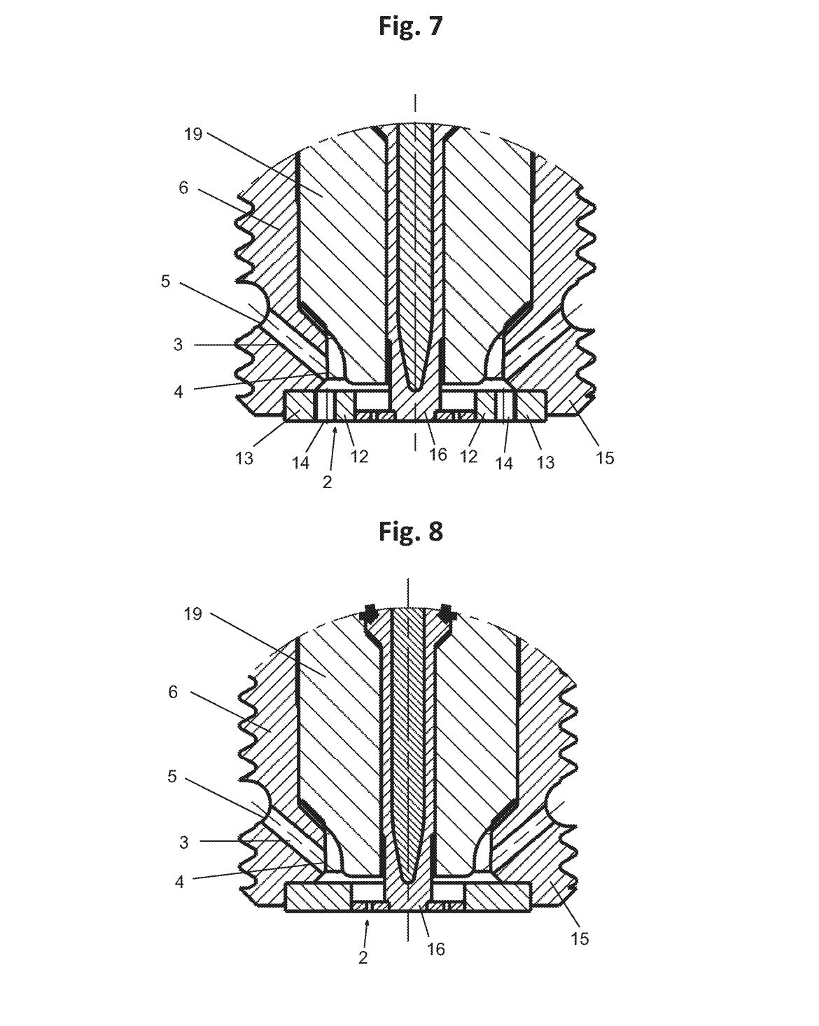

The position and direction of the gas scavenging spark gaps 14 in the spark plug 1 could either be directed towards the exit openings 4 in the mass electrode carrier 15 (“inline”) as in FIG. 7. In other words, each two spark gaps 14 in FIG. 7 are in the same plane with each two exit openings 4.

Or, as in FIG. 8, each two spark gaps 14 are shifted by any angle - preferably by 45° - related to the exit openings 4 in the mass electrode carrier 15 (“not inline”). In other words, each two spark gaps 14 in FIG. 8 are not in the same plane with each two exit openings 4.

Used reference signs:

1 spark plug

2 ignition device

3 supply channel

4 exit openings

5 entrance opening

6 base body

7 receiving cavity

8 circumference groove

9 mounting portion

10 cylinder head

11 spark plug sleeve

12 middle electrode

13 ground electrode

14 spark gap

15 ground electrode carrier

16 middle electrode carrier

17 pre-chamber

18 pre-chamber injector

19 insulator

20 pre-chamber body

21 central axis

1. A system, comprising:
a spark plug configured to ignite a combustible gaseous fuel mixture in an internal combustion engine, wherein the spark plug comprises:
an ignition area, wherein the spark plug is configured to deliver an ignition energy in the ignition area; and
at least one supply channel configured to convey a fuel and/or air, wherein the at least one supply channel has an exit opening at the ignition area and an entrance opening positioned distanced from the ignition area.

2. The system of claim 1, wherein the spark plug comprises a base body having a receiving cavity, wherein an ignition device is arranged at and/or in the receiving cavity, and the ignition device is at least partially surrounded by the base body.

3. The system of claim 2, wherein the exit opening is arranged in the receiving cavity.

4. The system of claim 2, wherein the base body comprises a circumferential groove along an outer surface, wherein the entrance opening of the at least one supply channel is placed at the circumferential groove.

5. The system of claim 2, wherein the spark plug comprises a mounting portion having a threaded surface configured to mount the spark plug in the internal combustion engine and/or in a cylinder head and/or in a spark plug sleeve, wherein the entrance opening is arranged at the mounting portion.

6. The system of claim 5, wherein the mounting portion at least partially surrounds the base body.

7. The system of claim 1, wherein an ignition device of the spark plug comprises at least one middle electrode and at least one ground electrode, wherein a spark gap is provided between the at least one middle electrode and the least one ground electrode.

8. The system of claim 7, wherein a base body of the spark plug is designed as a ground electrode carrier, wherein the at least one ground electrode is connected to the ground electrode carrier by laser beam welding.

9. The system of claim 7, wherein that the at least one ground electrode is designed as a ring electrode, wherein the ring electrode at least partially surrounds the at least one middle electrode of a circular shape, wherein an annular spark gap is formed between the at least one ground electrode and the at least one middle electrode.

10. The system of claim 9, wherein the at least one middle electrode is connected by laser beam welding at a middle electrode carrier.

11. The system of claim 10, wherein an isolator is arranged between the middle electrode carrier and the ground electrode carrier.

12. The system of claim 1, comprising the internal combustion engine comprising at least one cylinder head and the spark plug, wherein the spark plug is arranged at the cylinder head facing a pre-combustion chamber of the internal combustion engine, wherein an injector or a valve is fluidically connected to the entrance opening to supply air, fuel or air-fuel mixture by use of the at least one supply channel to the pre-combustion chamber passing via the ignition area of the spark plug.

13. A system, comprising:
an igniter of an internal combustion engine, comprising:
a body portion;
an ignition portion coupled to the body portion; and
at least one supply channel through the body portion to an ignition cavity having the ignition portion.

14. The system of claim 13, wherein the igniter comprises a spark plug.

15. The system of claim 13, comprising a pre-chamber assembly having the igniter coupled to the pre-chamber assembly, a fuel supply is fluidly coupled to the at least one supply channel, and the ignition cavity is fluidly coupled to a pre-chamber of the pre-chamber assembly.

16. The system of claim 13, wherein the ignition cavity is disposed in the body portion of the igniter.

17. The system of claim 13, wherein the body portion comprises external mounting threads.

18. The system of claim 13, wherein the body portion comprises a circumferential groove along an outer surface of the body portion, and the at least one supply channel comprises a plurality of supply channels extend from the circumferential groove to the ignition cavity.

19. A method, comprising:
routing a fluid flow through at least one supply channel of an igniter of an internal combustion engine, wherein the igniter comprises a body portion, an ignition portion coupled to the body portion, and a least one supply channel through the body portion to an ignition cavity having the ignition portion.

20. The method of claim 19, comprising:
supplying a fuel as at least part of the fluid flow;
cooling the igniter via the fluid flow comprising the fuel; and
igniting the fuel via the ignition portion.
